(19) United States
(12) Patent Application Publication
(10) Pub. No.: US 2010/0107898 A1
(43) Pub. Date: May 6, 2010

(54) MACHINE AND METHODS OF OPERATION FOR FRYING COMESTIBLES

(76) Inventor: Jim Vadevoulis, Riverwoods, IL (US)

Correspondence Address: SEYFARTH SHAW LLP, 131 S. DEARBORN ST., SUITE 2400, CHICAGO, IL, 60603-5803, US

(21) Appl. No.: 12/429,888

(22) Filed: Apr. 24, 2009

Related U.S. Application Data
(63) Continuation-in-part of application No. 10/963,409, filed on Oct. 12, 2004, now abandoned.

(51) Int. Cl. A47J 37/12

(52) U.S. Cl. 99/404; 99/403; 99/407

(57) ABSTRACT

An apparatus for preparing fried food chips includes a slicer for slicing whole foodstuffs into unfried chips, a cooking bath defined by a trough containing heated cooking medium, unfried chips being dispensed from the slicer into the cooking bath, the trough providing a cooking path, a submersion screen movable to receive the dispensed chips thereunder and moving along with the chips during at least a portion of the cooking to maintain the dispensed chips submerged, a motor system for mechanically communicating with and driving the submersion screen, and an output from the machine for receiving the cooked chips, wherein the cooking path is non-linear with portions disposed at a distance defining a central portion, and the motor system is mechanically connected with the submersion screen between the two cooking path portions in the central portion. A control system is provided for calculating production and a division of revenue based thereon.

### CROSS-REFERENCE TO RELATED APPLICATION

The application is a continuation-in-part of U.S. Ser. No. 10/963,409, filed Oct. 12, 2004, the entirety of which is incorporated herein.

### FIELD OF THE INVENTION

The invention relates to a machine and methods for frying comestibles and, in particular, to a small-scale, small-production, and point-of-sale machine for all steps of preparing and frying potatoes for potato chips.

### BACKGROUND

Currently, many machines are known for frying foodstuffs or comestibles. These machines include large, commercial machines used for mass production and packaging of potato chips for downstream distribution to retailers and, ultimately, to consumers. These machines also include smaller-scaled machines designed to produce fried foodstuffs, such as donuts or potato chips, in smaller retail establishments, enabling consumers to purchase product straight out of the machine and as freshly cooked as possible.

U.S. Pat. No. 2,615,485 describes a machine for cooking waffle batter for waffle cookies. The machine includes a circular oil bath and a central driven rod having a plurality of arms extending radially therefrom each of which includes a waffle iron. An annular or cylindrical portion is provided intermediate the irons and the driven rod, and the arms rest on and ride along the top surface of the cylinder. The top surface is shaped to have peaks and troughs so that the rotation of the arms cause the arms to rise and fall along with the top surface, thus enabling the waffle irons to be dipped in batter, rotated through the oil bath, and then lifted to have the cooked waffle cookie cleared from the iron. Accordingly, the entire impetus for circulating the oil is the motion of the waffle irons through the oil.

A similar device for cooking waffle cookies is shown in U.S. Pat. No. 4,026,202. The device includes a rectangular oil bath so that the irons take an oval or racetrack path. The heating elements are electrical elements that extend longitudinally along the extent of the rectangular cooking bath.

U.S. Pat. No. 1,629,355 shows an automatic potato chip maker. The device includes an input which includes a slicer or chipper for dispensing raw slices or chips into the cooking medium supported by a trough. The trough forms a non-linear path having four straight sections that double back upon each other with semi-circular portions joining each pair of straight sections, the trough terminating at a conveyor for lifting the chips from the trough. The sections are separated only by a thin partition. In order to direct the oil forward, the machine includes an impeller, something like a paddle wheel, driven by a motor and resting partially in the cooking medium. The heating elements are located below the trough so that the cooking medium must be heated therethrough.

U.S. Pat. No. 1,690,104 also shows a non-linear path for the potato chips and shows six straight sections connected by semi-circular portions. This patent shows a number of separate paddles in the respective straight sections for directing chips forward.

U.S. Pat. No. 3,280,723 shows a potato chip cooking machine having a non-linear path (with an upwardly extending divider) and having an enclosure. The machine includes a pump and a jet nozzle for directing the oil around the non-linear path of the trough.

Each of these machines utilizes and benefits from a non-linear cooking path, meaning that the cooking path does not follow simply a straight line. This allows the machine to be more compact.

More specifically, foodstuffs such as potato chips require a particular dwell time in the cooking medium before being removed. The rate of movement and the length of the cooking path determine the dwell time realized by a machine. The overall length of the machine, for a constant rate of movement, can be significantly shorter (nearly half) when the cooking path doubles back on itself. Alternatively, one may say that the rate of movement may be doubled if the cooking path is doubled, as can occur if the overall length of the machine is maintained by the cooking path returning. A higher rate of movement allows more chips to be in the cooking path at any particular time and results in a greater total production capability.

U.S. Pat. No. 4,195,559 shows a machine that may be used for cooking sliced food utilizing conveyor belts. However, the food is bacon and the screens are used to support the bacon, not to hold the bacon down from floating on top of a cooking medium. The screens do serve to advance the bacon along the cooking path.

A number of problems are associated with the prior art machines. For instance, the '202 patent shows the heating elements extending longitudinally from end, which results in uneven heating along the heating element and, thus, along the cooking path. For a continuously operating system in which the cooking medium is well-circulated, the uneven heating may not be an issue. However, the food may be too quickly or too slowly cooked at a particular point. Additionally, the uneven heating makes it difficult if not impossible to control the cooking on-demand, that is, for a point-of-sale machine that is activated for a particular batch when ordered as the machine would require some time to reach a point of stasis.

Other machines utilize heating elements located outside, i.e. below, the heating trough. This requires a significantly greater amount of energy to bring the cooking medium to temperature.

Another detriment of many of these machines is the manners in which the cooking medium and chips are advanced along the cooking path. For instance, the '723 patent uses a “jet nozzle” for directing the cooking medium around the path. Nozzles or other pump-based mechanisms suffer from potential clogging and require cleaning that is more extensive than cleaning of paddles, for instance. For many of the prior art systems, a paddle is used as the sole means for directing the cooking medium along the path, which is limited in force due as hazardous or messy splashing may result from a quickly moving paddle.

While the '559 patent discloses using a conveyor belt that assists in moving food forward along the cooking path, the '599 patent (assigned to General Foods Corporation) is for a large-scale commercial production of foodstuffs that are “fragile.” More importantly, the '559 patent is not directed to food stuffs that tend to float, and the conveyors are not used to submerge the food thereunder. As can be seen therein, the overall size of the machine is not an issue, and a linear path is utilized.

U.S. Pat. No. 6,602,533 discloses a linear potato chip machine and discloses wheels used to submerge the chips at least during a portion of the cooking path. Disclosed but not illustrated is use of a conveyor to submerge the chips.

Accordingly, there has been a need for an improved small-scale machine for making potato chips such as at a point-of-sale establishment.

### SUMMARY

In accordance with an aspect, an apparatus for preparing fried food chips from whole foodstuffs is disclosed, the apparatus including an input for providing whole foodstuffs to the apparatus, a slicer for slicing the whole foodstuffs into unfried chips, a cooking bath containing heated cooking medium, wherein the unfried chips are dispensed from the slicer into the cooking bath, and the cooking bath is defined by a trough thereof for supporting the cooking medium, the trough providing a cooking path, a submersion screen movable to receive the dispensed chips thereunder after an initial stage of cooking, the submersion screen moving along with the chips during at least a portion of the cooking and serving to maintain the dispensed chips submerged during said portion of the cooking, a motor system for mechanically communicating with and driving the submersion screen, and an output from the machine for receiving the cooked chips, wherein cooking path is non-linear and at least two portions thereof are disposed at a distance defining a central portion, and the motor system is mechanically connected with the submersion screen between the two cooking path portions in the central portion.

In some forms, the two cooking path portions are respective straight portions, and each straight portion is provided with a submersion screen. The respective straight portions may be parallel. The submersion screens may be endless belts of a conveyor system.

In some forms, the apparatus further includes heating elements, the heating elements extending laterally outward from the central portion.

In some forms, the central portion houses at least a first motor for driving the submersion screen, the mechanical connection therebetween being located on an upper surface of the central portion.

In some forms, the apparatus further includes a slicer having a rotating wheel with a blade secured thereto, a propulsion device for directing cooking medium of the cooking bath forward, the cooking medium carrying the dispensed unfried chips forward in an initial stage of cooking, the propulsion device being a paddle, and an output conveyor for removing cooked chips from the cooking bath.

In some forms, the apparatus further includes a blower assembly for removing excess cooking medium at an output of the apparatus.

In some forms, the apparatus further includes a heat-activated fire suppressions system.

In some forms, the apparatus further includes an air filtration system including a plurality of selectively removable filtration elements.

In some forms, the apparatus further includes a microprocessor-based electronic main control for controlling electrical operation of the apparatus.

In some forms, the apparatus further includes a removable cooking medium reservoir for removal and replacement of the cooking medium.

In another aspect, an apparatus for preparing fried food chips from whole foodstuffs is disclosed, the apparatus including an input for providing whole foodstuffs to the apparatus, a slicer for slicing the whole foodstuffs into unfried chips, a cooking bath containing heated cooking medium, wherein the unfried chips are dispensed from the slicer into the cooking bath, and the cooking bath is defined by a trough thereof for supporting the cooking medium, the trough providing a cooking path, a submersion screen movable to receive the dispensed chips thereunder after the initial stage of cooking, the submersion screen moving along with the chips during at least a portion of the cooking and serving to maintain the dispensed chips submerged during said portion of the cooking, a motor system for mechanically communicating with and driving the submersion screen, and an output from the machine for receiving the cooked chips, wherein the input is proximate the output so that the cooking bath trough includes at least two cooking path portions with opposite directions of movement during cooking, the two cooking path portions separated by a distance, and the motor system being mechanically connected with the submersion screen between the two cooking path portions.

In some forms, the apparatus further includes a propulsion device for directing cooking medium of the cooking bath forward, the cooking medium carrying the dispensed unfried chips forward in an initial stage of cooking.

In another aspect, an apparatus for preparing fried food chips from whole foodstuffs is disclosed, the apparatus including an input for providing whole foodstuffs to the apparatus, a slicer for slicing the whole foodstuffs into unfried chips, a cooking bath containing heated cooking medium, wherein the unfried chips are dispensed from the slicer into the cooking bath, and the cooking bath is defined by a trough thereof for supporting the cooking medium, the trough providing a cooking path, a submersion screen movable along the cooking path to receive the dispensed chips thereunder after an initial stage of cooking, the submersion screen moving along with the chips during at least a portion of the cooking and serving to maintain the dispensed chips submerged during said portion of the cooking, a motor system for mechanically communicating with and driving the submersion screen, and an output from the machine for receiving the cooked chips, wherein cooking path is non-linear and at least two portions thereof are disposed at a distance defining a central portion, and the motor system is mechanically connected with the submersion screen between the two cooking path portions in the central portion.

In another aspect, a system including an apparatus for preparing fried food chips and a control for operating said apparatus is disclosed, the system including the apparatus having an input for dispensing food chips, a cooking bath for supporting and retaining cooking medium, the cooking bath receiving the dispensed food chips, a heating system for heating the cooking medium, and an advancing system for advancing the food chips along a cooking path of the cooking bath, and the control including a main control for controlling the input, the heating system, and the advancing system.

In some forms, the main control is microprocessor-based. The main control may communicate with a remote operator via a communication line. The main control may communicate production totals for the apparatus to the remote operator. The control calculates a revenue division based on the production totals.

### BRIEF DESCRIPTION OF THE DRAWINGS

In the Figures, FIG. 1 is a perspective view of a small-scale foodstuff frying machine of the present invention including a non-linear path around a central portion for supporting submersions screens and heating elements, the machine having an enclosure portion with transparent sides, having an air assembly with outer portions being shown in phantom to illustrate internal components thereof, and having a base portion with side doors being shown in phantom to illustrate internal components therein;

FIG. 2 is a side elevational view of the machine of FIG. 1 showing a drain for communicating with an opening of a cooking medium reservoir;

FIG. 3 is a perspective view of a trough and cooking pan portion of a cooking assembly of the machine of FIG. 1 showing a U-shaped path for foodstuffs, and showing heating elements extending from and mounted with the central portion for heating cooking medium located in the trough;

FIG. 4 is a perspective view of a slicer assembly and feed tube of the machine of FIG. 1;

FIG. 5 is a perspective view of a portion of the machine of FIG. 1 with certain components removed to permit recognition of placement of other components as illustrated including conveyor assemblies having submersion screens, and a paddle wheel for initial impetus and propulsion of the sliced floodstuffs;

FIG. 6 is a perspective view of a conveyor assembly having a submersion screen;

FIG. 7 is an enlarged portion of the view of FIG. 5 showing an adjustment mechanism for positioning a leading end of a conveyor assembly;

FIG. 8 is an enlarged portion of the machine of FIG. 1 with components removed to expose an output conveyor assembly for removing cooked foodstuffs from the cooking bath and depositing same in an bowl at an output; and

FIG. 9 is a perspective view of the air assembly of the machine of FIG. 1.

### DETAILED DESCRIPTION

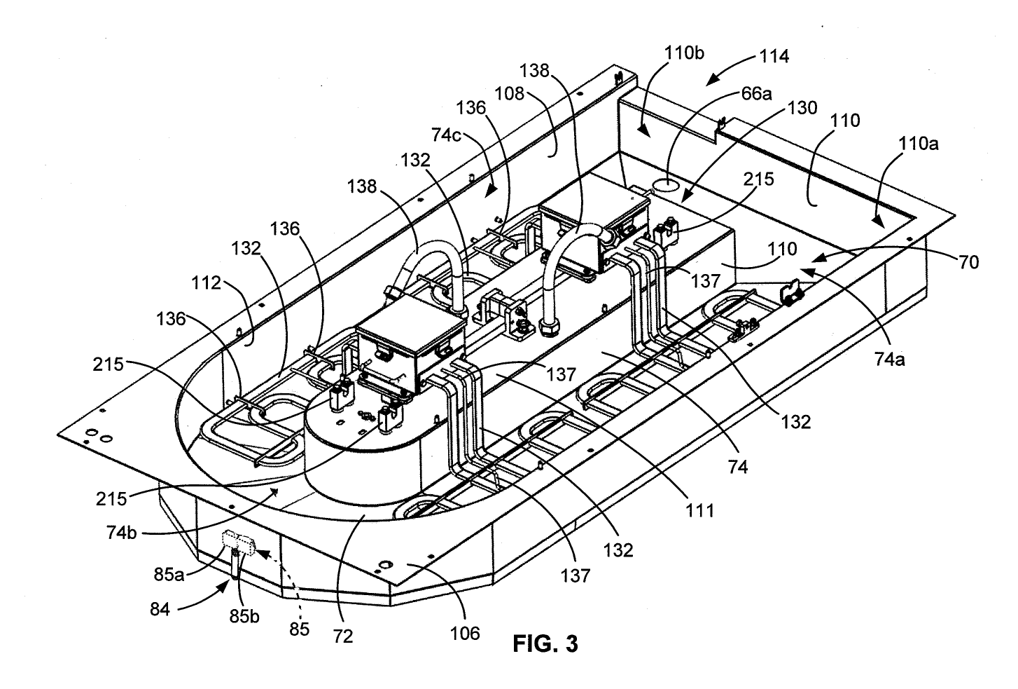

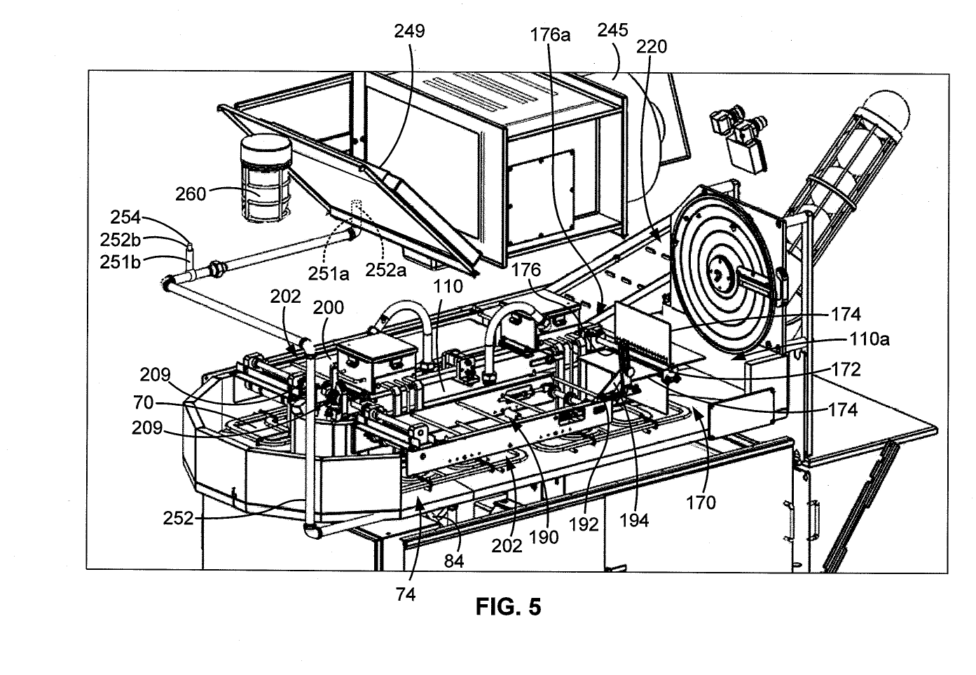

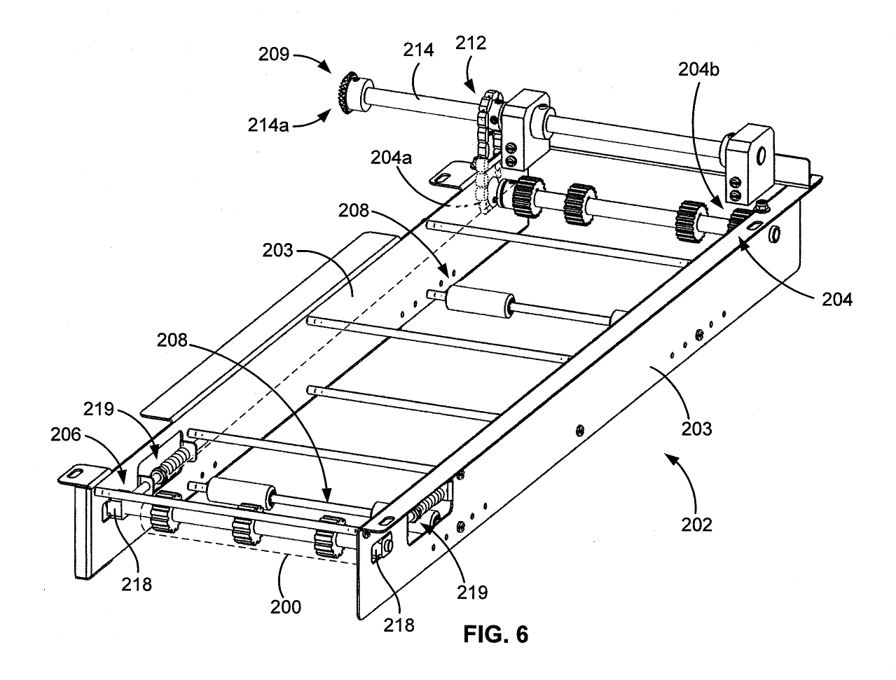

Referring initially to FIG. 1, a chip producing machine 10 is illustrated, the machine 10 being of a small scale for use at a point-of-sale such as a restaurant, grocery store, convenience mart, convention center, fair or carnival, park, concession stand, and the like. As will be discussed in greater detail herein, the machine 10 includes a non-linear path in which the path has portions separated by a distance, the distance providing a location for operating submersion screens 190, 200 (FIGS. 5 and 6) and heating elements 132 (FIG. 3) while maintaining a small-scale and other features of the machine 10. While the term “screen” is used, such is intended to refer to mesh, screen, or wire, for instance, that permits fluid flow therethrough. As an example of use, the machine 10 slices whole foodstuffs (raw potatoes, pitas, raw sweet potatoes, etc.) into chips, and cooks the chips in a cooking medium such as oil and, in the preferred form, peanut oil.

In greater detail, the machine 10 includes a frame 20 for supporting components and subassemblies of the machine 10. The frame 20 includes four vertically oriented posts 22 defining a base portion 32 and having a caster and wheel 24 at a lower end 22a thereof, the wheels 24 allowing the entire machine 10 to be moved easily. Proximate the lower ends 22a, the posts 22 are connected horizontally by four horizontally oriented stretchers 26 forming a rectangular shape with a longitudinal direction extending to an operation end 28 for the machine 10. Integral with the stretchers 26 or secured therewith is a horizontal support structure 30 in the form of bars, though a plate may be used.

Extending from posts 22 located at the operation end 28 is a pair of struts 36, angled upwardly and outwardly generally proximate or near the lower ends 22a. The struts 36 support a stage 38 mounted horizontally from the operation end posts 22. The stage 38, inter alia, supports a scale 40 and a bowl 42 thereon for measuring (weighing) cooked potato chips (not shown) from an output 44, detailed below.

Below the stage 38 and between the struts 36 is an access 50 to an area or volume 52 defined within the posts 22. More specifically, the access 50 includes an access door 54, behind which and within the volume 52 is a cooking medium filtration and disposal system, referred to herein simply as the filtration system 60.

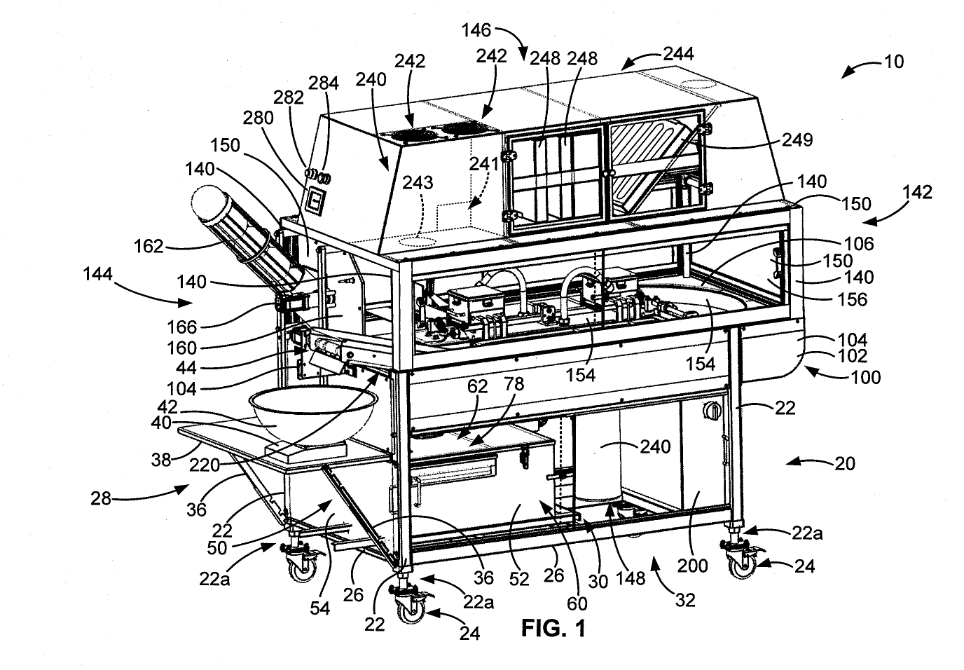

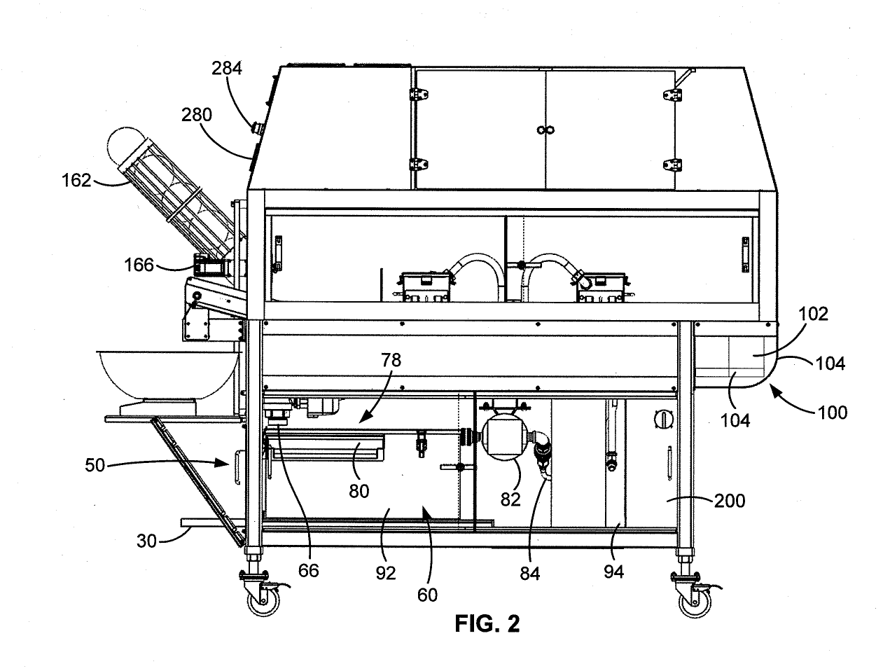

As can be seen in FIGS. 1 and 2, the filtration system 60 is generally box-like to define a cooking medium reservoir 62. A drain 66 is provided and, with further reference to FIG. 3, is mounted in a cooking bath 70 and, specifically, in a bottom pan 72 of a trough 74. The bottom pan 72 includes drain opening 66a, viewable in FIG. 3. The drain 66 is positioned over an opening 78 to the reservoir 62 and, when opened, allows the cooking medium from the cooking bath 70 to drain into the reservoir 62.

The filtration system 60 includes filter elements 80 and a pump 82 that draws cooking medium from the reservoir 62 (via a pump feed line located in the bottom of the reservoir, not shown) and directs the cooking medium through a return feed line 84, the output 85 (FIG. 3) of which is positioned in the trough 74. In the preferred form, the output 85 includes a pair of oppositely oriented ports 85a, 85b for directing the cooking medium in two different directions of the trough 74, as best illustrated in FIG. 3. Each of two longitudinal sides 90 of the base portion 23 includes access doors 92, 94 which allow a user to expose the filtration system 60 and remove the reservoir 62.

In operation, the cooking medium is easily filtered of particulate matter or entirely changed. The user may select (or the machine 10 may be programmed, as described below), filtration cycles so that the drain 66 is opened and the cooking medium empties (via gravity) into the reservoir 62 through the filter elements 80. The pump 82 may then operate to return the filtered cooking medium to the trough 74. Additionally, the filtration system 60 may filter the cooking medium multiple times in a single filtration operation by cycling the cooking medium multiple times, successively flushing and rinsing the trough 74.

Alternatively, as the cooking medium typically has a limited useful life, the cooking medium may be changed. To do so, one of the access doors 54, 92, 94 is opened to expose the filtration system 60. The reservoir 62 is removed including the cooking medium disposed therein. In various forms, the pump 82 (and an associated feedline, not shown) may be disconnected from the reservoir 62, while in other forms the pump 82 and return line 84 may also be removed for cleaning, or both. In the present form, the support structure 30 serves as rails for sliding the reservoir 62 through the access 50. In other forms, the reservoir 62 may simply be removed from the longitudinal side access doors 92, 94 so as not to interfere with the stage 38, for instance, which may hinder the usability of the machine during the reservoir removal.

Upper portions 22b of the posts 22 support a cooking assembly 100 including the above-noted cooking bath 70. Generally speaking, the cooking assembly 100 includes a pan 102 having four sides 104 secured with the posts 22. The four sides 104 are secured with and support a generally horizontal pan plate 106 which in turn supports the cooking bath 70. As can be seen in FIG. 3, the cooking bath 70 includes a trough 74 defined by an outer sidewall 108, the bottom pan 72, and an inner island 110. The sidewall 108 includes an operation endwall 110 and a U-shaped wall 112. As will be discussed below, the cooking path for a potato chip includes dispensing chips into the trough 74 at a position generally aligned with a first lateral end 110a of the endwall 110, then travel along a first straight 74a of the trough 74 to a curve 74b of the trough 74, then travel therefrom along a return portion or second straight 74c so that the cooking path is non-linear, that is, does not follow a straight line. The chip then exits the trough 74 at a second lateral end 110b of the endwall 110 via a conveyor 120 (discussed below) for which a notch 114 is formed in the endwall 110, thus partially defining the output 44.

As can also be seen in FIG. 3, a heating system 130 is provided for heating the cooking medium. The heating system 130 includes heating elements 132 extending laterally across the cooking path of the trough 74 and longitudinally through the straights 74a, 74c, resulting in more evenly-distributed heating as well as allowing the machine 10 to bring the cooking medium up to temperature quickly as a great majority of the cooking medium (located in the trough 74) is in close proximity to the heating elements 132. The heating elements 132 extend from electrical components 134 (such as transformers) mounted on a top surface 111 of the island 110. Brackets 136 are provided in the trough 74 for mounting and supporting the heating elements 132. Temperature probes 137 also extend into the trough 74 and are mounted with the components 134. The electrical components 134 are controlled (via supply and control lines (not shown) encased by conduit 138) by a main control 200 (FIG. 1, discussed below) that continually monitors the temperature of the cooking medium via the probes 136. To facilitate cleaning, the heating system 130 (other than the conduits 138) may be entirely lifted or raised relative to the island 110 and the trough 74, though this should only be done with the machine 10 and cooking medium cooled.

With continued reference to FIG. 1, the pan 102 supports a secondary set of posts 140 that, inter alia, define an enclosure 142, support a slicer assembly 144, support air assembly 146, and support a portion of a fire suppression system 148, each of which is discussed below.

The enclosure 142 is generally box-like and includes four sides 150. Longitudinal sides 152 may include sliding doors 154, and a distal endwall 156 as well as the longitudinal sides and doors 154 are preferably a heat-resistant transparent material so that an operator or a consumer may view therethrough to observe and monitor the production of the chip. The sliding doors 154 allow an operator to make minor corrections during operation, such as by removing or dislodging a potato chip that has become stuck.

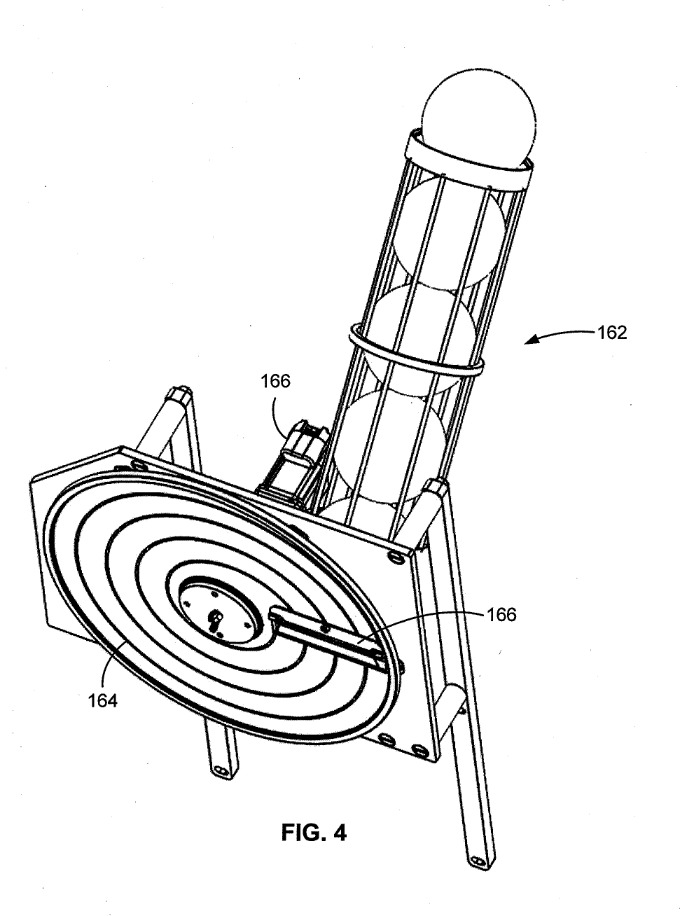

One of the sides 150, specifically input/output side or I/O side 160 is at the operation end 28 of the machine 10. The I/O side 160 supports the slicer assembly 144 and, thus, defines an input. More specifically, the slicer assembly 144 shown in FIG. 4 includes a feed tube 162 which is a wire tube in the present embodiment, though may be of any construction including a hopper.

As can be seen in FIG. 4, the feed tube 162 is gravity-assisted to feed foodstuffs such as raw potatoes (i.e., whole potatoes, though partial potatoes or skinned potatoes may be used) to a slicer wheel 164. The slicer wheel 164 is driven by a motor 166 positioned to a side of the feed tube 162, the motor 166 being controlled by the main control 200. For instance, machine 10 can be user-programmed to rotate the slicer wheel 164 a specific number of times (generally correlating to a specific number of potato slices) and then to pause for a specific time period.

The slicer wheel 164 supports and mounts a removable, replaceable, and adjustable blade 166. This allows a dull blade to be removed and either sharpened, honed, or replaced, allows different blades to be used such as for a wavy profile chip, and allows different thicknesses to be provided for the chips/slices.

As can be seen in FIG. 5, initial propulsion for the cooking medium and impetus for the slices is from a propulsion device in the form of a paddle wheel assembly 170. Once sliced, the raw chips fall into the cooking bath 70 and trough 74 proximate the endwall end 110a. The paddle wheel assembly 170 includes a paddle wheel 172 having a plurality of vanes 174 radially extending from an axle 176. The paddle wheel 172 is mounted so that the vanes 174 enter and exit the cooking medium in the trough 74 without the axle 176 entering the cooking medium. In one form, the height of the axle 176 is user adjustable (not shown). The paddle wheel axle 176 is driven at a drive end 176a by a motor (not shown), the drive end 176a being located at the island 110, and the motor may be located within the island 110 or below the cooking assembly 100.

The potato chips are preferably cooked in a submerged manner, though the chips themselves have a tendency to float. Generally speaking, the aforementioned submersion screens 12 provide a majority of the submersion for the chips, though the paddle wheel 172 may cooperate to assist. More specifically, the paddle wheel 172 often contacts the potato chips at the initial cooking path portion, and its action forces the chips downward. At this early stage, the chips are soft and relatively pliable.

In greater detail, the machine 10 includes the first submersion screen 190 and a second submersion screen 200. In the preferred form, each of the screens 190, 200 are endless belt screens of respective conveyor assemblies 202.

Turning to FIG. 6, the second submersion screen 200 is illustrated as part of a conveyor assembly 202. The conveyor assembly 202 includes a driven sprocket roller 204, a dead sprocket roller 206, and a pair of dead rollers 208. The driven sprocket roller 204 is mounted at each end 204a, 204b with side plates 203, and the inward end 204a (i.e., toward the island 110) is driven by a chain 212. The chain 212 itself is driven by a conveyor drive axle 214 supported at an inner end 214a by the island 110 on bushing 215 (FIG. 3), driven by a motor (not shown) and a pinion connection 209 therewith. The dead sprocket roller 206 is supported at its ends by brackets 218 of pair of spring-loaded tensioners 219 for maintaining the submersion screen 200 in tension around the rollers 204, 206, 208. The dead rollers 208 are positioned lower than the sprocket rollers 204, 206 so that the latter may be positioned above a level of the cooking medium, which reduces the cleaning required of the sprockets of the sprocket rollers 204, 206, and the chain 212. Provided the chain 212 remains clean, the drive axle 214 also need not be cleaned. It should be noted that the submersion screens 190, 200 rapidly heat and cool as they enter and exit the cooking medium, and the tensioners 219 accommodate these changes (which also create expansion and contraction of the submersion screens 190, 200).

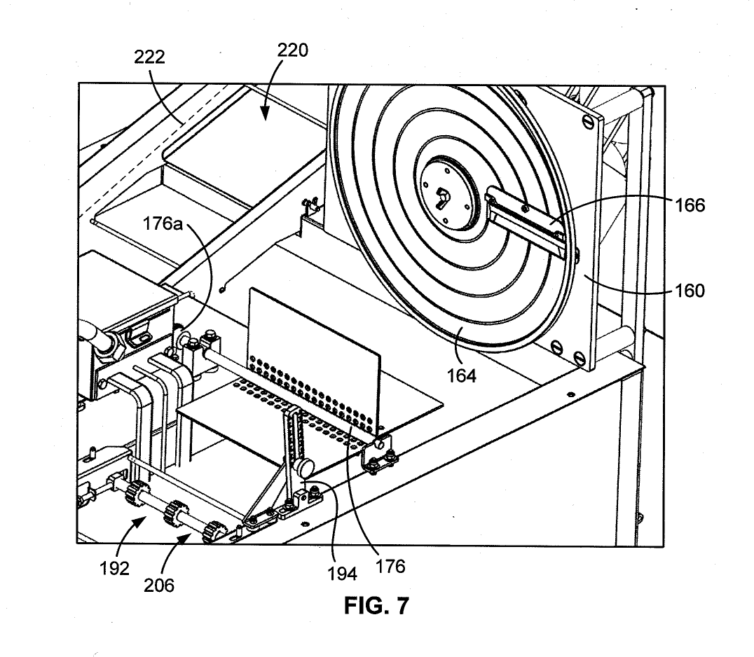

As can be seen in FIGS. 5 and 7, the first submersion screen 190 and its associated conveyor assembly 202 are largely identical to that of the second submersion screen 200. The first submersion screen 190 has a leading end 192 that is adjustable by an adjustment mechanism 194. However, for the first submersion screen, the leading end 192 is the non-driven end, and the tensioner brackets 218 are connected to the adjustment mechanism 194. In this manner, the leading end 192 may be raised or lowered to reduce the occurrence of the soft, pliable chips in the initial stage from becoming stuck to the submersion screen 190, that is, by raising the leading end 192 so that it is above the chips and cooking medium and all chips pass thereunder. It should be noted that such a feature may also be provided for the second submersion screen 200, though it is less of an issue as the chips partially are cooked when they reach the second submersion screen 200. Also, the ability to raise or lower the conveyor assemblies 202 promotes cleaning of the machine.

It should also be noted that the combination of the paddle wheel 172 and submersion screens 190, 200 (as well as an output conveyor 220) provide sufficient impetus for the cooking medium and chips that the chips continue through the curve trough section 74b. The machine 10 need not utilize a pump or other device for circulating the cooking medium. However, in another form, a secondary paddle (not shown) may be provided such as in the curved trough section 74b, the secondary paddle being driven by the pinion that is connected with the pinion connections 209 (FIG. 5).

After the chips have passed the second submersion screen 200, the output conveyor 220 removes the chips from the cooking bath 70. In the preferred form, the output conveyor 220 includes a screen/mesh/wire belt 222 so that cooking medium is permitted to drain. The output conveyor 220 has a leading end 224 with a dead sprocket or dead roller 226 on an axle 228 (with a tensioner 229), the leading end 224 positioned sufficiently within the level of cooking medium that chips do not pass thereunder and instead pass on top of the belt 222. The output conveyor 220 is angled upwardly to lift the chips out of the cooking medium.

Positioned above the output conveyor 220 is the air assembly 146 and, specifically, a motor driven fan 245 within a housing 246 (FIGS. 1, 8, and 9). In simple terms, the fan 245 forces air through opening 241 (FIG. 1) so that air is forced through both upper vents 242 for exhaust and through a lower vent 243 towards the chips on the output conveyor 220. In this manner, removal and drainage of the cooking medium from the chips on the output conveyor 220 is promoted.

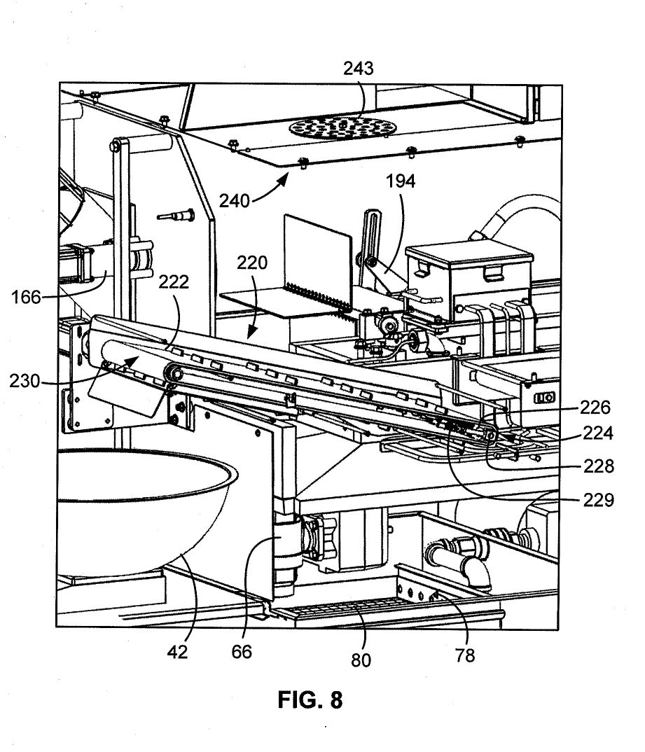

The chips are deposited at the output 44, specifically, from the output conveyor 220 at a trailing end 230 and, more specifically, are deposited into the bowl 42 on the scale 40, noted above (see also FIG. 8). Thus, a user or operator is able to weigh or measure the amount of chips produced so that saleable portions may be allocated. Additionally, the scale 40 may be in communication with the main control 200 so that the main control 200 can track total production of chips.

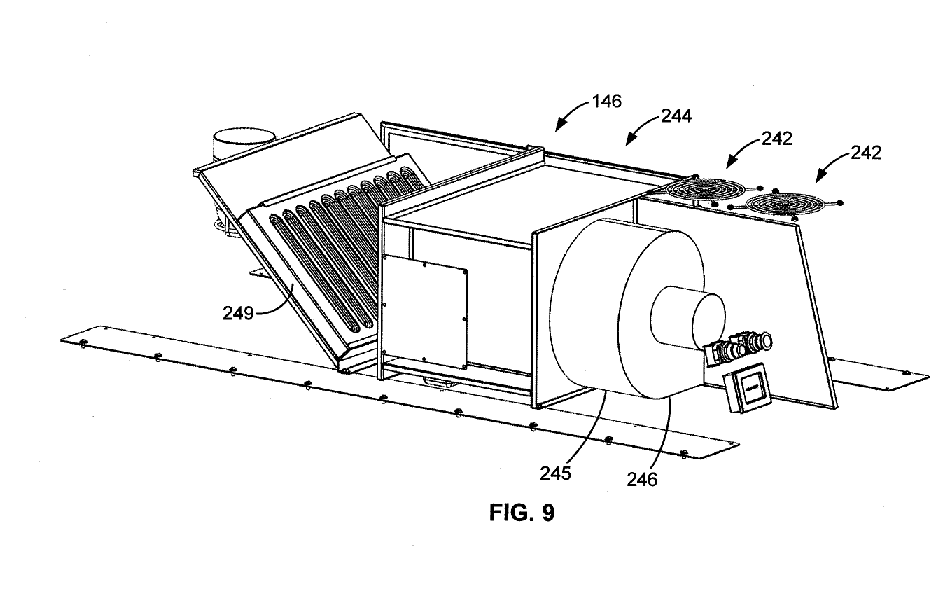

As shown in FIGS. 1 and 9, the air assembly 146 further includes an exhaust system 244 also relying on fan 245 located within a housing 246 for drawing hot and wet air from the enclosure 142. The air is drawn through a series of one to four filter elements 248, which are selectively removable allowing an operator to suppress smells from the machine or to stimulate the senses of consumers and potential customers by permitting a portion of the smells to emanate from the machine 10. A trap 249 is positioned in the airflow before the filter elements 248 for removing cooking medium that may be in the air.

The above-discussed enclosure 142 also provides measures of safety. Persons proximate to the machine are protected from splashing, splattering, or bumping of heating cooking medium, as well as are protected from emitted heat and vapors (such as steam from the cooking chips). Also noted above, a fire suppression system 148 is provided with the machine 10.

The fire suppression system 148 includes a canister 250 located in the volume 52 (FIG. 1). The fire suppression system 148 utilizes a disbursement and monitoring line 252 including a first standpipe 251a with terminus 252a located in the in the exhaust air of the exhaust system 244 and including a temperature sensor 254 at the tip of a second standpipe 251b having a terminus 252b. The fire suppression system 148 is heat activated; upon reaching a predetermined temperature (such as measured by the temperature sensor 254), the fire suppression system 148 automatically activates to douse any potential hazard with material (including fire suppression gas such as compressed CO₂) from the canister 250. In a preferred form, the temperature sensor 254 is a mechanical device so that no electricity is involved, such as a device that includes a valve that is heat opened to allow the material in the canister to be released through the standpipe sections 251a, 251b. Additionally, a heat-sensing cord may be located within the enclosure and distributed across a top surface therein to monitor heat levels throughout the space and report said levels to the main control 200. The enclosure 142 also serves to limit the disbursement of this material and, thus, to protect anyone proximate to the machine 10 when the fire suppression system is activated.

A light 260 is mounted within the enclosure 142. The light 260 is powered by the main control 200, which may be programmed to flash when the fire suppression system 148 is activated or other specified conditions.

Turning now to operation of the machine 10, the majority of activities are controlled by the main control 200 which, in the present embodiment, is mounted in the base volume 52. Thus, the main control 200 is located in the least heat-susceptible portion of the machine 10. The main control 200 operates and directs each of the motors and the heating elements 132, as well as the air assembly 146, and the slicer assembly 144, and other components as discussed above. The main control 200 is microprocessor-based system utilizing hardware, firmware, and software for electronic control of the machine 10.

A user can communicate with the main control 200 in a number of manners. A user panel 280 is provided on the machine 10 along with a power-on throw 282 and a full-off throw 284, the throws 282 and 284 being in the form of green and red push-buttons, respectively. The user panel 280 can be used to program a number of chips (turns of the slicer wheel 164), and a pause between sets of turns, and can be programmed for a particular product. For instance, different food stuffs may be cooked, such as pitas or sweet potatoes, and the temperature, inter alia, may be adjusted for other food stuffs. The user may indicate to the panel that a different food stuff is being cooked, and the main control 200 can adjust the speed of the conveyor assemblies 202 and temperature of the cooking medium accordingly. The main control 200 can also hold the slicer assembly 144 from slicing until the proper operating conditions for the programmed food have been reached, which includes a slice thickness for a potato chip.

Furthermore, the main control 200 is provided with remote and wireless communication, such as Internet or Wi-Fi communications. While it should be clear that doing so allows a remote person to operate the machine 10, there are a number of other benefits.

In a method for operating the machine, the product of chips and the life cycle of the cooking medium are monitored. This allows a remote monitor to determine supply needs, such as potatoes or other foodstuffs and cooking medium, to determine when cooking medium should be filtered or changed, and to monitor operating conditions for potential malfunctions or maintenance work (or activation of the fire suppression system 148).

Additionally, it allows a remote monitor to quantify an expected monetary output. For instance, in one business model, the machine 10 may be operated and located in a physical location, and the owner or operator of that location may agree to divide revenues with an owner of the machine 10. The owner, being the remote monitor, can verify production and use of the machine 10 to accurately track the product, which can then be correlated to a monetary output based on a provided sales price.

Returning to the specifics of the machine 10, the island 110 is an important feature or, rather, the distance between the straights 74a and 74c of the trough 74 are important. As discussed, the reduced size of a machine that is available from having the non-linear path (as the usage is defined herein) has been recognized as beneficial. The present machine 10 utilizes this feature with the trough 74 that receives the sliced potato, and then submerges the potato slices along the straights 74a and 74c via the conveyor assemblies 202. Heretofore, however, no prior art machine combined the non-linear path with the submerging of the chips during cooking.

Moreover, the distance between the straights 74a, 74c overcomes a number of technical hurdles. This distance, defining the island 110, supports the motor connections for the conveyor assemblies 202 so that a pair of conveyor assemblies 202 can be provided on the respective straights 74a, 74c with the overall size of the island no larger than is necessary for a single pinion connection 209 thereto. To be precise, the lateral size of the island 110 need only be such to provide for the pinion connections 209 and the heating elements 132, for instance, though the illustrated embodiment is wider than necessary. It is preferred for the width of the machine 10 to permit the machine 10 to pass through a standard doorway of a commercial establishment, and the present invention enables a machine width smaller than such doorway while accommodating the conveyor assemblies 202 and heating system 130. As an example, the width may be 36 inches.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

What is claimed is:

1. An apparatus for preparing fried food chips from whole foodstuffs, the apparatus comprising:
an input for providing whole foodstuffs to the apparatus;
a slicer for slicing the whole foodstuffs into unfried chips;
a cooking bath containing heated cooking medium, wherein the unfried chips are dispensed from the slicer into the cooking bath, and the cooking bath is defined by a trough thereof for supporting the cooking medium, the trough providing a cooking path;
a submersion screen movable to receive the dispensed chips thereunder after an initial stage of cooking, the submersion screen moving along with the chips during at least a portion of the cooking and serving to maintain the dispensed chips submerged during said portion of the cooking;
a motor system for mechanically communicating with and driving the submersion screen;
an output from the machine for receiving the cooked chips, wherein cooking path is non-linear and at least two portions thereof are disposed at a distance defining a central portion, and the motor system is mechanically connected with the submersion screen between the two cooking path portions in the central portion.

2. The apparatus of claim 1 wherein the two cooking path portions are respective straight portions, and each straight portion is provided with a submersion screen.

3. The apparatus of claim 2 wherein the respective straight portions are parallel.

4. The apparatus of claim 2 wherein the submersion screens are endless belts of a conveyor system.

5. The apparatus of claim 1 further including heating elements, the heating elements extending laterally outward from the central portion.

6. The apparatus of claim 1 wherein the central portion houses at least a first motor for driving the submersion screen, the mechanical connection therebetween being located on an upper surface of the central portion.

7. The apparatus of claim 1 further including a slicer having a rotating wheel with a blade secured thereto, a propulsion device for directing cooking medium of the cooking bath forward, the cooking medium carrying the dispensed unified chips forward in an initial stage of cooking, the propulsion device being a paddle, and an output conveyor for removing cooked chips from the cooking bath.

8. The apparatus of claim 1 further including a blower assembly for removing excess cooking medium at an output of the apparatus.

9. The apparatus of claim 1 further including a heat-activated fire suppressions system.

10. The apparatus of claim 1 further including an air filtration system including a plurality of selectively removable filtration elements.

11. The apparatus of claim 1 further including a microprocessor-based electronic main control for controlling electrical operation of the apparatus.

12. The apparatus of claim 1 further including a removable cooking medium reservoir for removal and replacement of the cooking medium.

13. An apparatus for preparing fried food chips from whole foodstuffs, the apparatus comprising:
an input for providing whole foodstuffs to the apparatus;
a slicer for slicing the whole foodstuffs into unfried chips;
a cooking bath containing heated cooking medium, wherein the unfried chips are dispensed from the slicer into the cooking bath, and the cooking bath is defined by a trough thereof for supporting the cooking medium, the trough providing a cooking path;
a submersion screen movable to receive the dispensed chips thereunder after the initial stage of cooking, the submersion screen moving along with the chips during at least a portion of the cooking and serving to maintain the dispensed chips submerged during said portion of the cooking;
a motor system for mechanically communicating with and driving the submersion screen; and
an output from the machine for receiving the cooked chips, wherein the input is proximate the output so that the cooking bath trough includes at least two cooking path portions with opposite directions of movement during cooking, the two cooking path portions separated by a distance, and the motor system being mechanically connected with the submersion screen between the two cooking path portions.

14. The apparatus of claim 13 further including a propulsion device for directing cooking medium of the cooking bath forward, the cooking medium carrying the dispensed unfried chips forward in an initial stage of cooking.

15. An apparatus for preparing fried food chips from whole foodstuffs, the apparatus comprising:
an input for providing whole foodstuffs to the apparatus;
a slicer for slicing the whole foodstuffs into unfried chips;
a cooking bath containing heated cooking medium, wherein the unfried chips are dispensed from the slicer into the cooking bath, and the cooking bath is defined by a trough thereof for supporting the cooking medium, the trough providing a cooking path;
a submersion screen movable along the cooking path to receive the dispensed chips thereunder after an initial stage of cooking, the submersion screen moving along with the chips during at least a portion of the cooking and serving to maintain the dispensed chips submerged during said portion of the cooking;
a motor system for mechanically communicating with and driving the submersion screen; and
an output from the machine for receiving the cooked chips, wherein cooking path is non-linear and at least two portions thereof are disposed at a distance defining a central portion, and the motor system is mechanically connected with the submersion screen between the two cooking path portions in the central portion.

16. A system including an apparatus for preparing fried food chips and a control for operating said apparatus, the system comprising:
the apparatus including:
an input for dispensing food chips,
a cooking bath for supporting and retaining cooking medium, the cooking bath receiving the dispensed food chips,
a heating system for heating the cooking medium, and
an advancing system for advancing the food chips along a cooking path of the cooking bath; and
the control including a main control for controlling the input, the heating system, and the advancing system.

17. The system of claim 16 wherein the main control is microprocessor-based.

18. The system of claim 17 wherein the main control communicates with a remote operator via a communication line.

19. The system of claim 18 wherein the main control communicates production totals for the apparatus to the remote operator.

20. The system of claim 19 wherein the control calculates a revenue division based on the production totals.
